(19) United States
(12) Patent Application Publication
(10) Pub. No.: US 2007/0252390 A1
(43) Pub. Date: Nov. 1, 2007

(54) Renewable Energy Resources

(76) Inventor: David Hyman Gordon, Glasgow (GB)

Correspondence Address: Louis M Heidelberger;Redd Smith, 2500 One Liberty Place, 1650 Market Street, Philadelphia, PA, 19103, US

(21) Appl. No.: 10/580,171

(22) PCT Filed: Nov. 18, 2004
(86) PCT No.: PCT/GB04/04859

§ 371 Date: Feb. 28, 2007

(30) Foreign Application Priority Data
Nov. 19, 2003 (GB) 0326879.4
Mar. 15, 2004 (GB) 0405799.8

(51) Int. Cl. F03D 9/00; H02J 9/00

(52) U.S. Cl. 290/44; 290/55; 307/68

(57) ABSTRACT

Wind power is used to generate electricity as A.C. that can be used to supplement or replace national grid power. A plug-in unit takes electrical power from one or more wind generators and delivers the required A.C. to the mains.

This invention concerns renewable energy resources.

Wind energy has great potential as a renewable energy source. A recent report examining different renewable energy resources found that a total of 60 GW of cost effective renewable energy was available with the top two sources in terms potential being offshore wind (25 GW) and wave energy (14 GW). The next largest source of renewable energy is onshore wind (12 GW).

Currently wind power is used to generate electrical energy for the national grid. That requires large-scale commercial wind farms but they are expensive to set up due to the high cost of the generators required.

In our earlier patent application WO 03/067801 a system was proposed for generating electrical power for an individual property comprising a wind powered electricity generator mounted on that property and arranged so that electrical power generated be used in that property in preference to or to supplement electrical power provided by the national grid or other general electrical energy.

In other words, when there is sufficient wind power to generate electrical energy for an individual property's demands, that electrical energy be used rather than the electricity supplied by the national grid. In that way the drain on the resources of the national grid can be cut, so that national supply costs can also be reduced.

It was, therefore, proposed that an individual property have at least one wind powered generator, such as a wind vane or vanes, mounted in a suitable position on the property exposed to the prevailing wind. The wind vane preferably comprised at least one multi-bladed rotor that drives an electricity generator.

The present invention now proposes improvements to that system.

According to a first aspect of the invention there is provided a wind generator arrangement for use in generating electrical power, the arrangement comprising a plurality of wind generators in at least two rows, wherein generators of any one row are at a different height to those of adjacent rows and/or a wind generator of one row is offset relative to any wind generators of an adjacent row.

The arrangement of this aspect of the invention is to avoid operation of each wind generator being adversely affected by air currents produced by operation of adjacent generators.

Preferably each wind generator will be mounted on a height adjustable pole, such as a telescopic pole. Preferably the wind generators are mounted on a platform that is itself mountable on a roof or other suitable structure.

In a preferred embodiment a wind generator is rotably mounted on a support pole off centre thereof. The wind generator preferably has a tail fin that is offset towards the opposite side of the support pole. The tail fin is preferable spring loaded so as to give under predetermined wind speeds to cause the generator and its driving blades to deviate from the optimum wind direction. The tail fin also preferably has a damper to control the rate of reaction to wind speed changes.

Preferred wind generators for the invention have a three bladed rotor.

According to a second aspect of the invention there is provided a wind generator for producing electrical power in response to wind power acting on a rotor, wherein the generator is rotatably mounted on a support post or the like off centre thereof.

The wind generator of the second aspect of the invention preferably has a tail fin that is offset towards the opposite side of the support post. The tail fin is preferably spring loaded, so as to give under predetermined wind speeds to cause the generator and its driving blades to deviate from the optimum wind direction. The tail fin also preferably has a damper to control the rate of reaction to wind speed changes.

Preferred wind generators for use in the invention initially produce A.C electrical power and are preferably linked to means for converting that A.C into A.C compatible with the A.C. provided to the building.

According to another aspect of the invention there is provided means for converting electrical power generated by one or more wind generators into A.C. suitable for use in providing electrical power for a building to supplement or replace electrical power supply from the national grid.

According to a fourth aspect of the invention there is provided a system for converting electrical power produced by wind generators into A.C. suitable for use in providing electrical power for a building to supplement or replace electrical power supply from the national grid, the system comprising one or more wind generators for producing A.C. from wind power and a control unit for converting the generated A.C. into A.C. in the same phase and at the same voltage as the A.C. supply from the national grid.

The wind generator may be according to the first or second aspects of this invention.

The means according to this aspect of the invention preferably takes the A.C. current produced by the wind generators through a full wave internally or externally mounted rectifier to convert it to D.C., which may be smoothed further by means of capacitors. From the rectifier, the D.C. is preferably converted to square wave A.C., such as by means of a chopper circuit also known as an H bridge network. This A.C. is preferably then converted to sine wave A.C., such as by means of a constant voltage transformer or other suitable electrical, electronic or electromechanical device. This A.C. is preferably compatible with the A.C. supply from the normal utility supplier to the building. The means for converting the D.C to A.C. preferably has means for ensuring that the A.C. produced is in phase with and at the same voltage as the A.C. supply from the normal utility supplier to the building.

The constant voltage transformer is preferably a multi-tapped constant voltage transformer. The appropriate tap is selected by voltage sensing circuits and varied as necessary to optimise the wind power. At the appropriate power level the means according to the invention switches into the mains electricity supply. The means is preferably referenced from the main electrical support, so that voltage, frequency and phase angle are maintained in alignment with the mains supply.

Preferably the means for converting electrical power generated by one or more wind generators into A.C. suitable for use in providing electrical power for a building to supplement or replace electrical power supply from the national grid is provided in a box or case to which the wind generators can be connected and which itself can be connected into the electrical circuitry of the building to feed the load thereon.

It is also possible for the means according to the invention to produce D.C. for other purposes. For this purpose the A.C. from the generator only needs to be rectified.

This invention will now be further described, by way of example only, with reference to the accompanying drawings, in which:

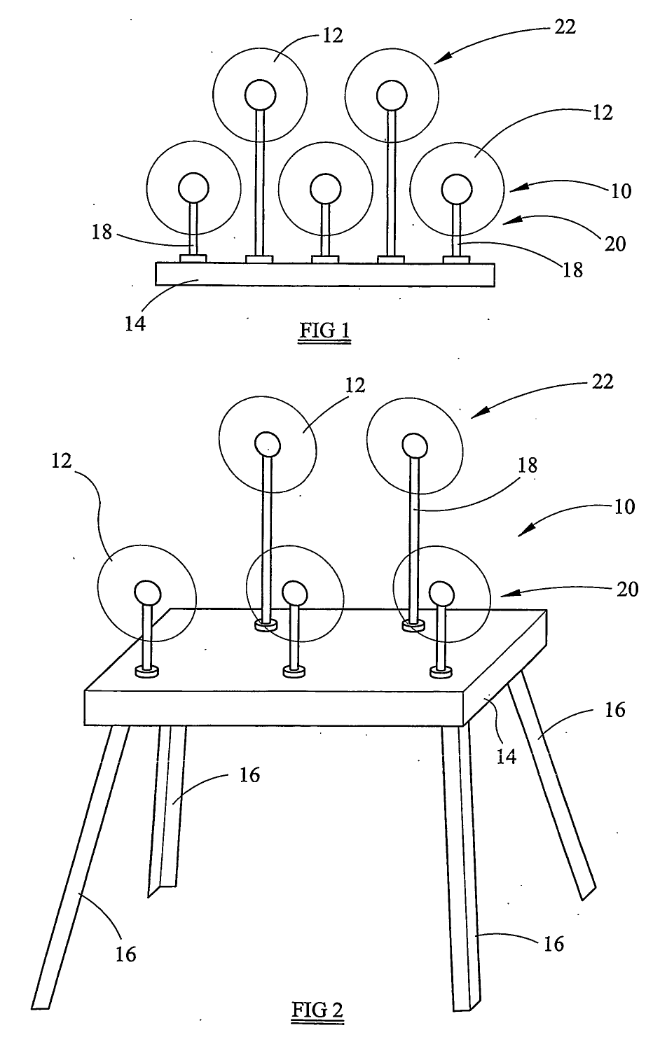

FIGS. 1 and 2 are schematic diagrams of a wind generator arrangement for mounting on a roof;

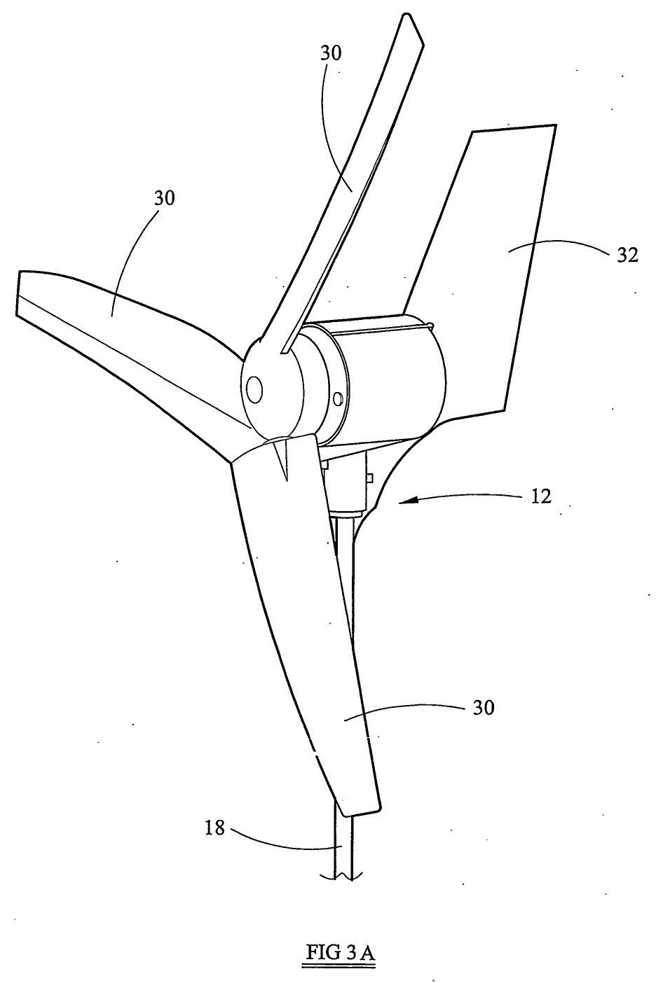

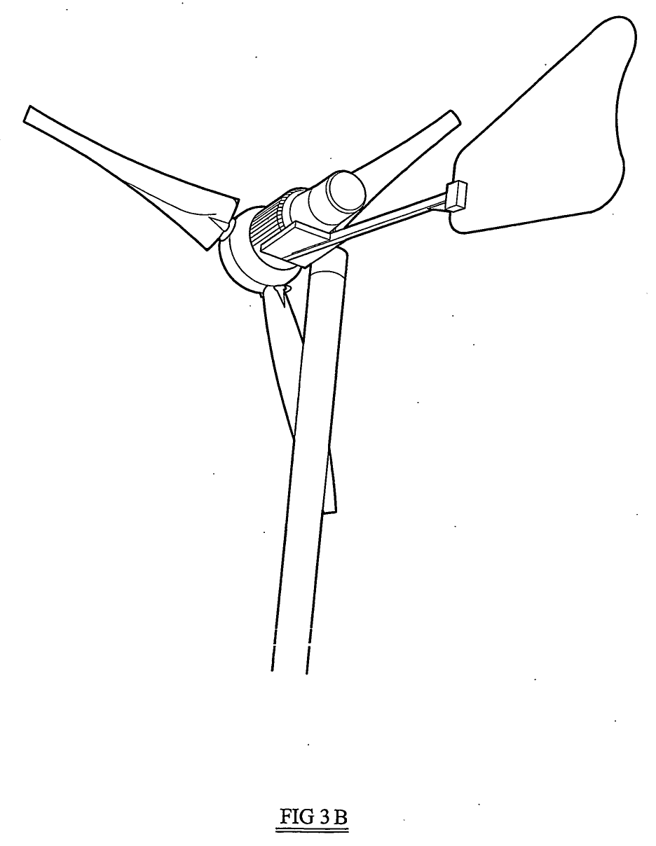

FIG. 3A shows a wind generator for use in the arrangement of FIGS. 1 and 2;

FIG. 3B shows an alternative wind generator for use in the arrangement of FIGS. 1 and 2;

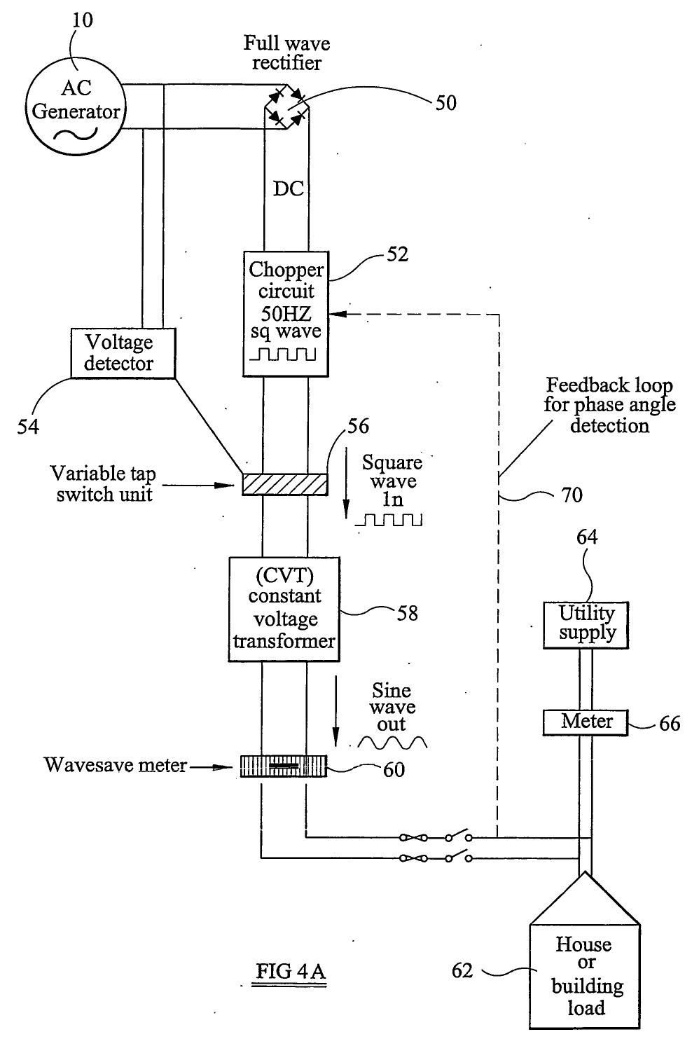

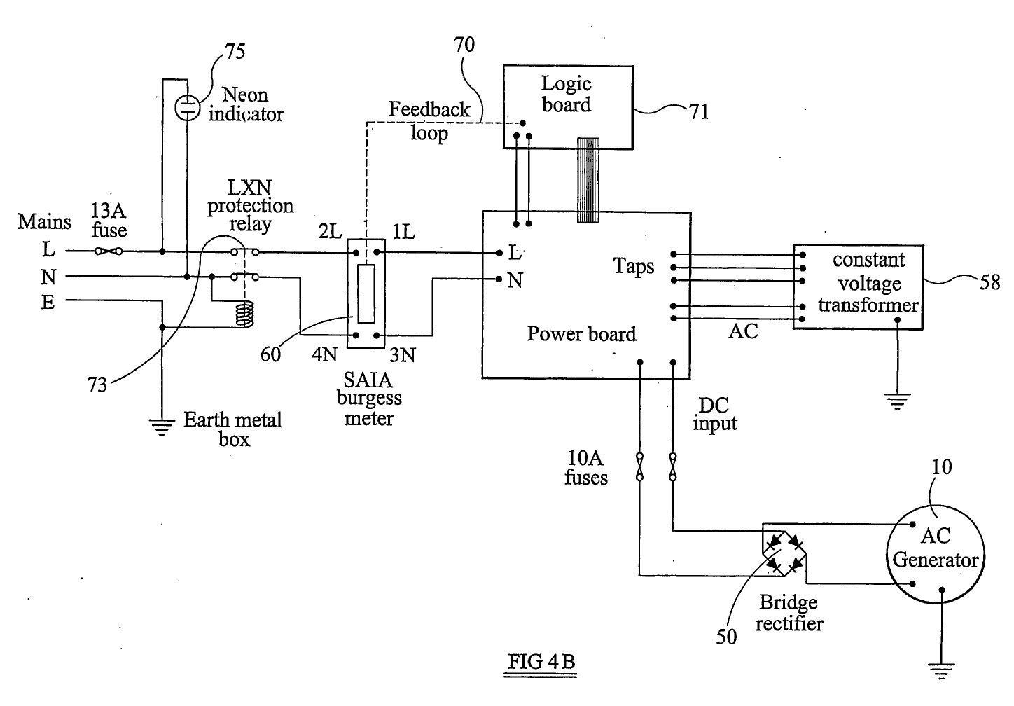

FIG. 4A shows schematically a control system for converting wind generated electrical power into A.C. for use in a building;

FIG. 4B shows an alternative control system; and

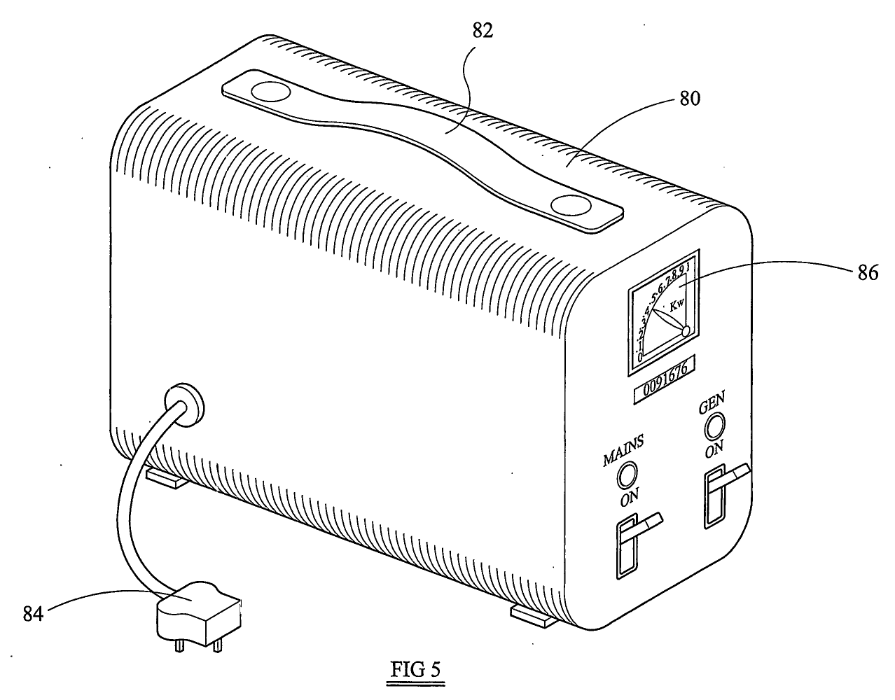

FIG. 5 shows schematically a control unit of the invention.

Referring to FIGS. 1 and 2 of the accompanying drawings, an arrangement 10 of wind generators 12 for mounting on a roof for use in generating electrical power comprises a platform 14 supported on legs 16, one at each corner. The legs are of adjustable length and angle to suit the location, where the platform is to be mounted.

The wind generators 12 are mounted on poles 18 at spaced intervals. The poles are height adjustable by being telescopic. There are two rows 20 and 22 of wind generators.

It is important that to reduce interference between the rows of generators the generators of the one row be staggered relative to the generators of the other row. Thus, the generators of the rear row 22 are positioned between the generators of the front row 20 as viewed from the front and are also higher than the wind generators of the front row. Thus, viewed from the front none of the generators overlaps with another generator. This reduces the impact of air currents produced by one generator affecting the operation of adjacent generators.

FIG. 3A of the accompanying drawings shows a typical wind generator 12 for use in the arrangement of FIGS. 1 and 2. The generator 12 is mounted on a pole 18 and is allowed to rotate through 360°. The generator has three blades 30 on a horizontal axis that are aerodynamically shaped to be caused to rotate on the axis to generate electrical power. The generator has a tail fin 32 that causes the generator to swivel to a position where the blades are facing into the prevailing wind.

In FIG. 3B, an alternative generator 100 is shown. The generator is mounted in such a position as to be exposed to the wind and as driven by a three blade propeller 102. The generator is mounted on pole 104 off-centre and is capable of 360° rotation. The off-centre mounting gives the unit a tendency to try and turn away from facing the wind. This force is counteracted by tail fin 106 being offset in the opposite direction. The tail fin 106 spring loaded and damped, so that, in the event of the wind reaching an excessive speed, the spring will give allowing the tail angle to change and so cause the generator and propeller to deviate from the optimum direction of the wind. The tail fin also has a damper to control the rate of the reaction. The output of the generator is 3 phase A.C., which is rectified to D.C. The D.C. is fed to a pair of slip rings and carbon brushes to allow the power to be conducted from the moving generator to the static cable and then on to a control system (see FIG. 5).

With a start-up speed of approximately 3 m/sec the system will begin to generate useable power and may deliver 1000 W at 12 m/sec. In gale force conditions [over 34 mph] a cut-off device prevents damage from over-fast rotation by applying a braking effect within the generator. As an additional safety measure the tail fin that causes the unit to face the wind has a spring loaded/damped furling sail to turn it away from high winds.

Turning to FIG. 4A there is shown a typical control system for converting electrical power generated by the arrangement of FIG. 1 into electrical power that can be used to supplement or replace electrical power supplied to a building from the normal utility supply. The wind generator arrangement 10 produces an A.C. electrical current, which is fed through a full wave rectifier 50 to convert it to D.C. and then through a chopper circuit 52 to produce 50 Hz square wave A.C. Across the chopper 52 is a voltage detector 54 linked to a variable tap switch unit 56 prior to a constant voltage transformer 58 that produces A.C. at 240 volts and 50 Hz in sine wave form. The output from the constant voltage transformer 58 is passed through a meter 60 before being fed to the power supply for the building 62, where it joins the power supply from the normal utility supply 64 after the usage meter 66 therefor.

It is important that the A.C. supply from the wind generators is in phase with the national grid A.C. supply. Therefore, a feedback loop for phase angle detection 70 is provided between the wind generator generated electricity supply and the chopper circuit 52, whereby the chopper circuit is controlled to produce A.C. of the correct phase in alignment with the mains supply.

FIG. 4B of the accompanying drawings shows another control circuit for converting the A.C. generated by a wind generator into A.C. in the same phase and at the same voltage as the mains supply. The circuit is similar to that shown in FIG. 4A and only the main differences will now be described.

The meter 60 is now a SAIA Burgess meter, which is connected by the feed back loop to the logic board 71 for phase angle detection. Between the meter 60 and the mains connectors, there is a LXN protection relay 73, which is provided to protect against damage from incorrect connection of the control system to the mains. Also, there is a neon indicator 75 to show In practice, as illustrated in FIG. 5 of the accompanying drawings, the means for converting the A.C. or D.C output of the wind generators 12 will be fed to a portable control box 80 containing the components described above for converting the D.C. output into A.C. output. The control box 80 optionally has a carrying handle 82 and can be plugged directly into a socket of the building's electrical circuit by means of electrical plug 84 or other suitable connection to at least partially feed the load of the building. The control box includes a wattmeter 86. Thus, the electricity power generator system may be installed relatively easily by siting the wind generators in an exposed position, especially on a roof, connecting the electricity supply therefrom to the control box 70 and connecting that into the electricity circuit of the building via a mains socket.

As an option a sensor may be provided on the incoming mains electricity supply that measures wattage or in other words what the grid is supplying to the household need. The sensor would be arranged to communicate with the control box 80, so that if the import wattage falls to a predetermined level, say of 20 watts, the control unit can be instructed to reduce efficiency to prevent actual export of power back to the grid. As the import wattage increases to say 50 watts due to decreased efficiency or reduced wind power, the control unit improves efficiency to a level, whereby the predetermined levels are maintained or the maximum wind power is used.

When mains power fails, the control unit has to disconnect and shut down. However, if stand alone wind power electricity supply is required, the control unit may be disconnected from the main supply to be allowed to operate independently. An isolating switch may be provided, which can be automatically or mechanically operated to allow the control unit to provide stand alone power and feed whatever power it can from the wind to be used by the household. The control unit may have an electrical power storage facility, such as rechargeable batteries. The control unit is provided with means for detecting when mains power is restored, which either may provide a signal to indicate that reconnection of the control unit can take place or even automatically reconnect the control unit.

The control unit may be arranged, so that there is no possibility of excess power being fed back to the grid. Thus, the control unit may be arranged to supply slightly less power than the household demand. However, the control unit may be configured, if desired, to feed power back into the grid.

The control unit and wind generator system may incorporate the following features:

1. The generator blades may be designed so as to have a self-regulated stall effect.

2. The generator tail fin to cause it to face the wind may have a spring loaded/damped furling tail to turn it away from high winds.

3. The generator may have a built-in centrifugally operated switch, which is manually resettable after operation, in order to apply a braking effect on the generator. The switch preferably comes into operation at a pre-determined rotational speed, such as of the order of 1160 rpm.

4. The control unit may have the facility to apply a similar braking force in the event of the voltage rising too high or at other times as the system dictates.

5. The control unit may have a manually operable switch for stopping the generator such as during prolonged absences, excessive storm conditions or for maintenance purposes.

6. An additional switch may be fitted locally to the generator to enable the control unit to be switched to brake, such as when working in close proximity or for maintenance purposes.

7. Standard electrical fuse protection is preferably provided in the control unit.

8. The control unit preferably includes means for preventing incorrect connection of the mains electricity supply or the generator supply.

9. The control unit preferably includes a temperature sensor. The sensor is preferably arranged to activate a cooling fan when a first pre-determined temperature is reached and preferably also to shutdown the unit when a second pre-determined temperature is reached.

10. The control unit is preferably arranged to shut down and apply brake to the generator in the event of mains failure.

1-37. (canceled)

38. A system for converting electrical power produced by wind generators into A.C. power for use in providing electrical power for a building to supplement or replace electrical power supply from the national grid, the system comprising one or more wind generators for producing A.C. from wind power and a control unit for converting the generated A.C. into A.C. in the same phase and at the same voltage as the A.C. supply from the national grid.

39. A system as claimed in claim 38, wherein the or each wind generator is mounted on a height adjustable pole.

40. A system as claimed in claim 39, wherein the height of the pole is telescopically adjustable.

41. A system as claimed in claim 38, wherein the or each wind generator is mounted on a platform that is itself mounted on a roof or other suitable structure.

42. A system as claimed in claim 38, wherein the wind generators are rotatably mounted.

43. A system as claimed in claim 38, wherein a wind generator is rotatably mounted on a support pole off centre thereof.

44. A system as claimed in claim 43, wherein the wind generator has a tail fin offset towards the opposite side of the support pole.

45. A system as claimed in claim 44, wherein the tail fin is spring loaded.

46. A system as claimed in claim 44, wherein the tail fin has a damper for controlling rate of reaction.

47. A system as claimed in claim 38, wherein the wind generator has a three-bladed rotor.

48. A system as claimed in claim 38, wherein A.C. current produced by the wind generators is taken through a full wave internally or externally mounted rectifier to convert it to D.C.

49. A system as claimed in claim 48, wherein from the rectifier, the D.C. is converted to square wave A.C.

50. A system as claimed in claim 49, wherein the D.C. is converted to A.C. by means of a chopper circuit.

51. A system as claimed in claim 50, having means for converting the converted A.C. to sine wave A.C.

52. A system as claimed in claim 51, wherein the means for converting A.C. to sine wave A.C. is a constant voltage transformer.

53. A system as claimed in claim 38, including means for producing the sine wave A.C., so as to be in phase with and at the same voltage as the A.C. supply from the normal utility supplier to the building.

54. A system as claimed in claim 38, provided in a box or case to which the wind generators can be connected and which itself can be connected into the electrical circuitry of the building to feed the load thereon.

55. A system as claimed in claim 38, comprising a plurality of wind generators in at least two rows, wherein generators of any one row are at a different height to those of adjacent rows and/or a wind generator of one row is offset relative to any wind generators of an adjacent row.
